(19) United States
(12) Patent Application Publication
(10) Pub. No.: US 2016/0298959 A1
(43) Pub. Date: Oct. 13, 2016

(54) CALIBRATION OF MOTION SYSTEMS

(71) Applicant: RENISHAW PLC, Gloucestershire (GB)

(72) Inventor: Kevyn Barry JONAS, Clovedon (GB)

(73) Assignee: RENISHAW PLC, Gloucestershire (GB)

(21) Appl. No.: 15/100,869

(22) PCT Filed: Dec. 5, 2014
(86) PCT No.: PCT/GB2014/053620

§ 371 Date: Jun. 1, 2016

(30) Foreign Application Priority Data
Dec. 6, 2013 (GB) 1321594.2

(51) Int. Cl. G01B 21/04

(52) U.S. Cl. CPC G01B 21/042

(57) ABSTRACT

The position measuring system of a motion system such as a coordinate measuring machine is calibrated for static errors using one or more accelerometers. A displacement of the motion system is measured both using the position measuring system and by double integrating the outputs of the accelerometers. The displacement measurements using the accelerometers are less subject to static errors, or their static errors are repeatable and can be corrected. Comparing them with the measurements using the position measuring system therefore produces difference values, which can be used to build an error map or error function for correcting the static errors of the position measuring system.

### FIELD OF THE INVENTION

This invention relates to the calibration of motion systems in which a relatively movable member is displaceable with respect to a relatively fixed member.

Examples of motion systems include coordinate measuring machines, manual coordinate measuring articulating arms, inspection robots, machine tools, printing systems, precision stages, pick-and-place machines and the like. The movable member may, for example, support a tool for operating on a workpiece or other object. Or it may support a workpiece or sample. In the case of a coordinate measuring machine, the tool may be a probe for use in measuring the workpiece.

### DESCRIPTION OF PRIOR ART

In known motion systems, a relatively movable member is displaceable with respect to a relatively fixed member. A position measuring system measures the relative displacement. If the motion is motorised, the position measurement system may provide feedback of the position to control the motor(s) in a servo loop.

Conventional motion systems utilise so-called serial kinematics. There is a chain comprising two or more serially-connected movable members. These are connected one to the next via sliding or rotary joints. For example, the members may be carriages which are respectively slidable on two or three orthogonal axes X, Y or X, Y, Z. Each axis may have a respective transducer such as an encoder which measures the displacement of the respective carriage in the corresponding direction, in order to give an X, Y or X, Y, Z coordinate position of the final movable member of the chain (or of the tool mounted on it). Additional axes of motion may also be provided (e.g. rotary axes). Alternatively, an articulating arm may have several rotary joints arranged in series, each with a rotary transducer such as a rotary encoder.

Together these transducers may be considered as a position measuring system for the whole multi-axis machine. Or each individual axis of motion can be considered as a one-dimensional motion system, with the respective transducer forming an individual position measuring system for that axis.

Another known type of motion system utilises parallel kinematics. This may for example comprise three or six extensible struts which are each connected to act in parallel between the movable member and a relatively fixed base member or frame. The movement of the movable member in an X, Y, Z working volume of the system is then controlled by coordinating the respective extensions of the three or six struts. Examples of parallel kinematics machines are shown in International Patent Applications WO 03/006837 and WO 2004/063579.

Parallel kinematics systems also have position measurement systems which provide an X, Y, Z coordinate position of the movable member. Typically this may comprise transducers such as encoders which measure the extensions of the struts, from which the X, Y, Z coordinate position can then be calculated.

Motion systems suffer from various static errors (also called “geometric” errors because they may arise from geometric inaccuracies of the system configuration or the transducers). These mean that the position measurement system does not give an accurate reading of the position of the movable member when it is stationary. It is known to calibrate machines to correct for such static errors. See for example U.S. Pat. No. 4,819,195 (Bell et al) which shows calibration of the static (geometric) errors of a three dimensional serial kinematic coordinate measuring machine, using instruments such as laser interferometers, electronic levels and ball bars. This is a very time consuming and expensive process.

Some motion systems also suffer from dynamic errors (also called inertial errors). These are caused, for example, by bending of various components of the machine while it is moving, as a result of accelerations. Dynamic errors may also be caused by vibration. Such dynamic bending or vibration causes motions of the movable member which may not be transduced accurately by the position measuring system. However, while some multi-axis serial kinematic machines are prone to such bending and to dynamic errors, the construction of other motion systems may provide relatively stiff or rigid coupling between the movable member and the point at which the transducer(s) of the position measuring system transduce its motion, so that dynamic errors are reduced. Examples of such relatively stiff systems may include parallel kinematic machines, single axis systems (and the individual single axes of multi-axis serial kinematic machines) and systems such as machine tools having component parts which are massive and therefore inherently stiff. Other motion systems may have mechanical frequency responses which provide relatively rigid coupling when moved at certain frequencies but not when moved at other frequencies.

U.S. Pat. No. 6,868,356 (Nai et al) shows a serial kinematic coordinate measuring machine with X, Y, Z sliding axes, and position measurement transducers which measure the displacement in the X, Y, Z axes. To solve the problem of dynamic errors, one or more accelerometers are mounted on the movable member of the machine, in order to measure its accelerations. The accelerometer outputs can be double integrated to give a displacement value indicating the dynamic error. This is then added to the output of the position measurement transducers. Any motion which is untransduced by the X, Y, Z position measurement transducers is thus measured in real time by the accelerometers. The dynamic errors (and the necessary corrections) are thus determined in real time.

However, such accelerometer information does not correct for static errors of the position measurement transducers. In fact, to the contrary, U.S. Pat. No. 6,868,356 suggests that the position measurement transducers can be used to calibrate the accelerometer data for various static errors. Any static errors of the position measurement transducers must therefore be determined separately, and as noted above this can be time consuming and expensive.

### SUMMARY OF THE INVENTION

The present invention provides a method of calibrating static error in a motion system, the system comprising:
a relatively fixed member and a relatively movable member; and
a position measuring system for determining the position of the movable member relative to the fixed member, the determination being subject to static error;

the method comprising:
providing one or more inertial sensors which are arranged to move with the movable member and to measure displacement of the movable member;
causing a displacement of the movable member relative to the fixed member;
measuring the amount of said displacement using the one or more inertial sensors;
measuring the amount of said displacement using the position measuring system; and
comparing the amount of the displacement as measured using the position measuring system with the amount of the displacement as measured using the one or more inertial sensors;

wherein:
the comparison produces a difference value for use in subsequent correction of one or more static errors of the position measuring system.

The displacement measured using the one or more inertial sensors may be less subject than the position measuring system to any static errors of the motion system; or not subject to static error at all.

In some cases it may be possible simply to trust the accuracy of the inertial sensors in this regard. In other cases, this may be achieved by a direct calibration of the displacement measured with the one or more inertial sensors against a reference standard external to the motion system. Or the same effect may be achieved indirectly by measurement of a reference standard on the motion system, for example correcting the difference value (or a scaling factor or error map or error function derived from the difference value) by a comparison with such a measurement of a reference standard.

It may be arranged that any dynamic or motion-induced errors of the system which appear in the measurements of the inertial sensor(s) are small compared to the static error of the position measuring system. To achieve this, the inertial sensor(s) may be mounted at a part of the motion system which is mechanically coupled to the point(s) at which transducer(s) of the position measuring system transduce its motion, the mechanical coupling being sufficiently rigid to assure that any dynamic errors of the system which appear in the measurements of the inertial sensor(s) are small compared to the static error of the position measuring system. Alternatively or additionally, the displacement of the movable member during the calibration of the system may be an oscillation at a frequency where the mechanical frequency response of the system assures that the mechanical coupling is sufficiently rigid to provide such assurance. Thus the measurements of the movable member using the inertial sensor(s) are relatively unaffected by dynamic errors.

Alternatively this rigid coupling may be because the motion system is sufficiently stiff inherently (e.g. it may be a parallel kinematic system, or a machine tool with relatively massive components).

By comparing the same displacement as measured by both the position measuring system and the accelerometers, a static error value results. This can be stored and subsequently used to correct static errors arising from the position measuring system. Such a static error value should be distinguished from the dynamic errors measured using accelerometers in the prior art, since in the embodiments of the invention under discussion the dynamic errors are preferably negligible.

Preferably the inertial sensor(s) are mounted at a part of the motion system which is mechanically coupled to the point(s) at which transducer(s) of the position measuring system transduce its motion, the mechanical coupling being sufficiently rigid to assure that any dynamic errors in the measurements made using the inertial sensor(s) are small compared to the static error of the position measuring system.

The movable member may be movable over a relatively large range, and the steps of measuring the displacement of the movable member may take place over a relatively small range. The displacement over the small range may be produced by an oscillation of the movable member. The oscillation may be at a frequency where the mechanical frequency response of the system assures that the mechanical coupling is sufficiently rigid.

The measurements of the displacement of the movable member may be repeated during the oscillation, and the difference value may be averaged from the repeated measurements. The oscillation may be produced by a circular motion of the movable member.

Preferably respective difference values are produced for displacements caused at a plurality of relative positions of the fixed and movable members, and the difference values are used to form an error map or error function of the static errors of the motion system. The step of displacing the movable member over a small range and the steps of measuring its displacement may be repeated at a plurality of different relative positions of the fixed and movable members, to produce a respective difference value for each position.

A cumulative error of a position measurement made using the position measuring system over a relatively large range of movement of the movable member may be calculated by integrating a plurality of said difference values for positions lying within the relatively large range. An error map or error function may be derived which gives a respective cumulative static error for each of a plurality of positions of the movable member.

An “error map” as discussed in this specification may include, for example, a look-up table of values for the correction of subsequent measurements.

The one or more inertial sensors may include one or more accelerometers. The displacement measured by the one or more accelerometers may be obtained by double integrating the accelerometer output or outputs. The one or more inertial sensors may be removable from the motion system when not required for calibration, e.g. they may be provided in a module which can be attached to and detached from the motion system.

Further aspects of the invention include methods of using a motion system, in which a static error is corrected by applying a correction derived by a method as above. The invention also includes motion systems configured to perform any of the above methods.

### BRIEF DESCRIPTION OF THE DRAWINGS

Embodiments of the invention will now be described by way of example, with reference to the accompanying drawings, wherein:

FIG. 1 shows operative parts of a comparative gauging machine with a motion system using parallel kinematics;

FIG. 2 shows a coordinate measuring machine (CMM) with a motion system using serial kinematics;

FIG. 3 shows an inertial sensor arrangement for use during calibration of either of the machines of FIG. 1 or FIG. 2;

FIG. 4 is a flow chart of a first part of a preferred method of calibration of a machine of FIG. 1 or FIG. 2;

FIG. 5 is a diagrammatic representation of the movement of the machine during the calibration;

FIG. 6 illustrates positions within the working volume of the machine during the calibration;

FIG. 7 is a flow chart of a further part of the calibration method; and

FIG. 8 shows a motorised stage and a part of a gauging machine in an alternative embodiment of the invention.

### DESCRIPTION OF PREFERRED EMBODIMENTS

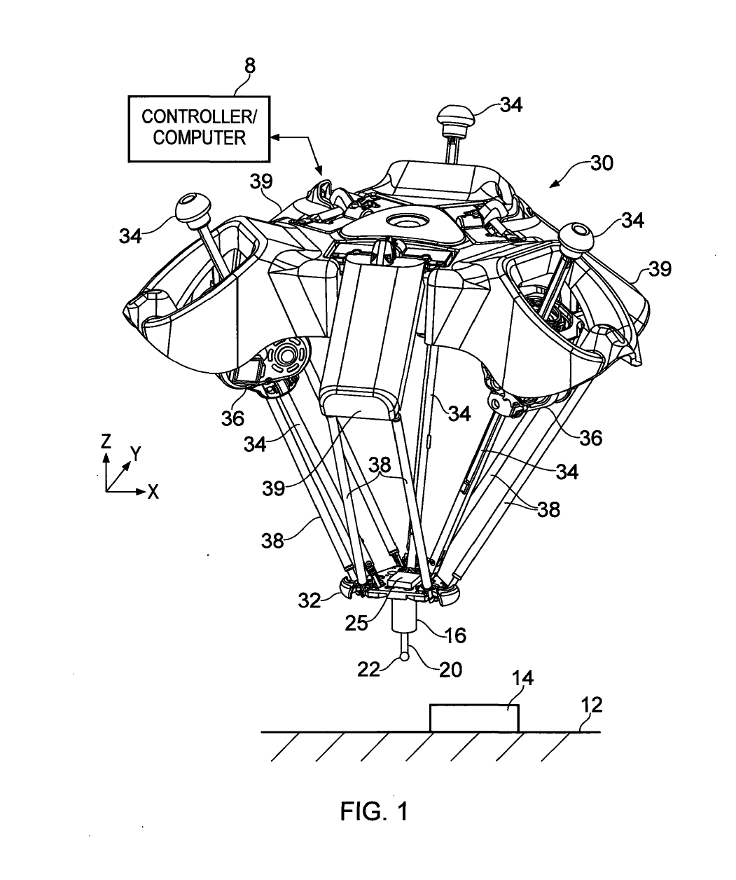

FIG. 1 is an illustration of parts of comparative gauging machine as sold by the present applicants Renishaw plc under the trademark EQUATOR. It comprises a fixed platform 30 connected to a movable platform 32 by a parallel kinematic motion system. In the present example, the parallel kinematic motion system comprises three struts 34 which act in parallel between the fixed and movable platforms. The three struts 34 pass through three respective actuators 36, by which they can be extended and retracted. One end of each strut 34 is mounted by a universally pivotable joint to the movable platform 32, and the actuators 36 are likewise universally pivotably mounted to the fixed platform 30.

The actuators 36 each comprise a motor for extending and retracting the strut, and a transducer which measures the extension of the respective strut 34. In each actuator 36, the transducer may be an encoder comprising a scale and readhead, with a counter for the output of the readhead. Each motor and transducer forms part of a respective servo loop controlled by a controller or computer 8.

The parallel kinematic motion system also comprises three passive anti-rotation devices 38, 39 which also act in parallel between the fixed and movable platforms. Each anti-rotation device comprises a rigid plate 39 hinged to the fixed platform 30 and a parallel, spaced pair of rods 38 which are universally pivotably connected between the rigid plate 39 and the movable platform 32. The anti-rotation devices cooperate to constrain the movable platform 32 against movement in all three rotational degrees of freedom. Therefore, the movable platform 32 is constrained to move only with three translational degrees of freedom X, Y, Z. By demanding appropriate extensions of the struts 34, the controller/computer 8 can produce any desired X, Y, Z displacement or X, Y, Z positioning of the movable platform.

The principle of operation of such a parallel kinematic motion system is described in our U.S. Pat. No. 5,813,287 (McMurtry et al). It is an example of a tripod mechanism (having the three extending struts 34). Other motion systems e.g. with tripod or hexapod parallel kinematic mechanisms can be used.

Taken together, the transducers of the three actuators form a position measuring system. This determines the X, Y, Z position of the movable platform 32 relative to the fixed platform 30, by appropriate calculations in the controller or computer 8. These calculations are known to the skilled person. The position thus determined by the position measuring system is however subject to static errors. Methods are discussed below for calibrating the position measuring system for these static errors, prior to using the machine to measure workpieces.

Typically an analogue probe 16 having a deflectable stylus 20 with a workpiece contacting tip 22 is mounted on the movable platform 32 of the machine, although other types of probes (including touch trigger probes) may be used. The machine moves the probe 16 relative to a workpiece 14 on a table 12 in order to carry out measurements of features of the workpiece. The X, Y, Z position of a point on the workpiece surface is derived by calculation from the transducers in the servo system, in conjunction with the outputs of the analogue probe 16. This is all controlled by the controller/computer 8. Alternatively, with a touch trigger probe, a signal indicating that the probe has contacted the surface of the workpiece freezes the X, Y, Z position value calculated from the output from the transducers and the computer takes a reading of the coordinates of the workpiece surface. If desired, for gauging operations during normal production use, automatic means such as a robot (not shown) may place each of a succession of substantially identical workpieces from a production run in at least nominally the same position and orientation on the table.

FIG. 2 illustrates an alternative coordinate measuring machine (CMM) 10 with a serial kinematic motion system. It comprises a fixed table 112 upon which a workpiece 114 to be measured may be placed. An analogue probe 116 having a deflectable stylus 120 with a workpiece contacting tip 122 is mounted on a movable quill 118 of the machine, although again other types of probes (including touch trigger probes) may be used.

The quill 118 and probe 116 are mounted via a serial kinematic motion system to move together in X, Y and Z directions, either manually or under the action of X, Y and Z axis motors controlled by a controller and/or computer 108. Various serial kinematic motion systems are known and can be used. In the present example, the serially connected members of the serial kinematic system comprise a bridge structure 124 which is movable in the Y axis direction on the table 112. A carriage 126 is movable in the X axis direction on the bridge 124. And the quill 118 holding the probe 116 is movable in the Z axis direction relative to the carriage 126.

The Y axis motion of the bridge 124 relative to the table 112 is measured by a Y axis transducer 128. Again this may be an encoder comprising a scale and readhead, with a counter for the output of the readhead. Similar X and Z axis transducers (not shown) are provided to measure the X axis motion of the carriage 126 relative to the bridge 124, and the Z axis motion of the quill 118 relative to the carriage 126. The transducer outputs are fed back to the computer or controller 108. They may be used in respective servo feedback loops with the X, Y and Z axis motors in order to control the X, Y, Z positioning of the quill and probe. They are also combined with signals from the probe 116 indicating the deflection of the probe stylus 120, to calculate the position of the stylus tip 122 and thus measure the surface of the workpiece 114 e.g. while the probe scans over the surface.

The X, Y and Z axis transducers form a position measuring system for the machine, which is subject to static errors as described above for FIG. 1. Again, the methods described below are used to calibrate the position measuring system for these static errors, prior to using the machine to measure workpieces.

In use, the controller or computer 8, 108 in FIGS. 1 and 2 contains a program which causes the probe 16, 116 to scan the surface of the workpiece 14, 114. Or for a touch trigger probe it causes it to contact the surface of the workpiece at a plurality of different points, sufficient to take all the required dimensions and form of the workpiece for the inspection operation required. This controller/computer may also be used to run programs which control the calibration methods which will be described below.

For use in the calibration methods, FIG. 1 shows that an inertial sensor arrangement 25 is mounted on the movable platform 32 of the parallel kinematic machine. The inertial sensor arrangement 25 may be provided permanently on the movable platform, but preferably it is a module which is mounted there temporarily and removed when calibration is completed. This enables the same inertial sensor module to be used for calibrating other machines.

FIG. 2 shows that an inertial sensor arrangement 125 may similarly be mounted on the movable quill 118 of the serial kinematic machine. Again, it may be provided there permanently, but preferably it is mounted there temporarily and removed when calibration is completed, so that it can be used in the calibration of other machines.

In either case, the probe 16, 116 may be exchangeable, and the inertial sensor arrangement 25, 125 may be temporarily mounted in its place. The probe 16, 116 is not required during the calibration described below.

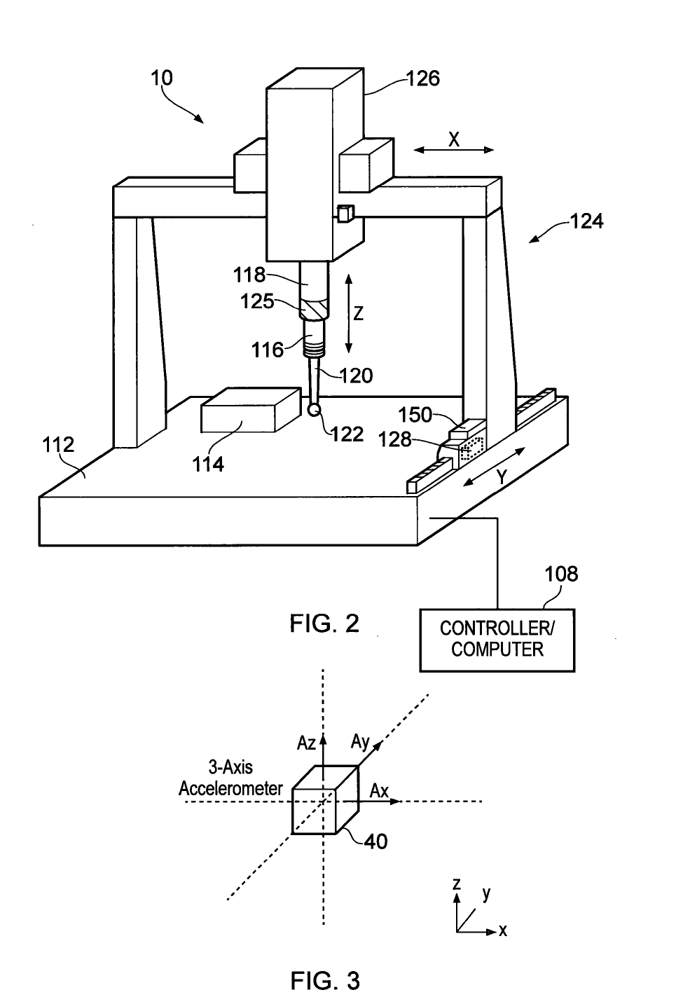

FIG. 3 shows an example of the inertial sensor arrangement 25 or 125. It comprises a three axis accelerometer 40, which measures linear accelerations Ax, Ay, Az in the three orthogonal axis directions X, Y, Z. The outputs of the inertial sensors are taken to the controller/computer 8, 108. As discussed below, these outputs are double integrated, either in a discrete signal processing circuit or in the controller/computer, in order to give X, Y, Z displacement values. Of course, other arrangements of inertial sensors are possible. For example, the three axis accelerometer 40 may be replaced by three single axis linear accelerometers.

As discussed in more detail below, the location of the inertial sensor arrangement depends on the stiffness of the structure of the machine. For a given accuracy requirement, the mounting position chosen should be at a location on the movable structure which is sufficiently close to the transducer, such that it may be considered as being rigidly coupled mechanically to the points at which the transducers (e.g. encoders) of the machine's position measurement system transduce the motion of the movable structure. In some cases, particularly in a serial kinematic machine of relatively low stiffness, it may instead be preferred to mount one or more inertial sensor arrangements in locations which are associated with the respective transducers which measure the X, Y, Z motion of the machine. FIG. 2 shows an inertial sensor 150 mounted on the movable bridge structure 124, in association with the transducer 128 which measures the Y axis motion of the bridge. Similar considerations apply to inertial sensor arrangements (not shown) which may be provided in association with the X and Z axis transducers.

An inertial sensor arrangement such as 150, which relates to one particular axis of movement, may simply comprise just one single-axis linear accelerometer aligned with the axis of movement concerned. This will enable the calibration of static errors such as scale errors. However, a three axis accelerometer arrangement may be provided if it is desired to calibrate other static errors of this axis of movement (including straightness errors in relation to the other two axes).

Any type of accelerometer may be used which enables the acceleration of the movable structure to be measured. One suitable type of accelerometer is made from micro-machined silicon. Another comprises piezoelectric crystals supporting a free mass. Capacitance accelerometers may also be used.

The displacement as measured using the raw output of the accelerometers (or other inertial sensors) may not be accurate. In particular, the measurement of the displacement may suffer from static scaling errors. In one preferred method, therefore, this measured displacement is directly calibrated against an external reference standard. This is because it is used for subsequent correction of the static errors of the position measuring system of the machine. The accelerometer data can be calibrated on a more accurate external CMM, e.g. using the method described in U.S. Pat. No. 6,868,356 (Nai et al) on the external CMM. Or it can be calibrated as described by Swavik A. Spiewak in “Versatile Inertial Displacement Sensor for Planar Motion”, Proceedings of the 2005 International Conference on MEMS, NANO and Smart Systems (ICMENS'05), 463-466.

However, as an alternative to such direct calibration of the inertial sensors, we describe later how the same effect can be achieved indirectly.

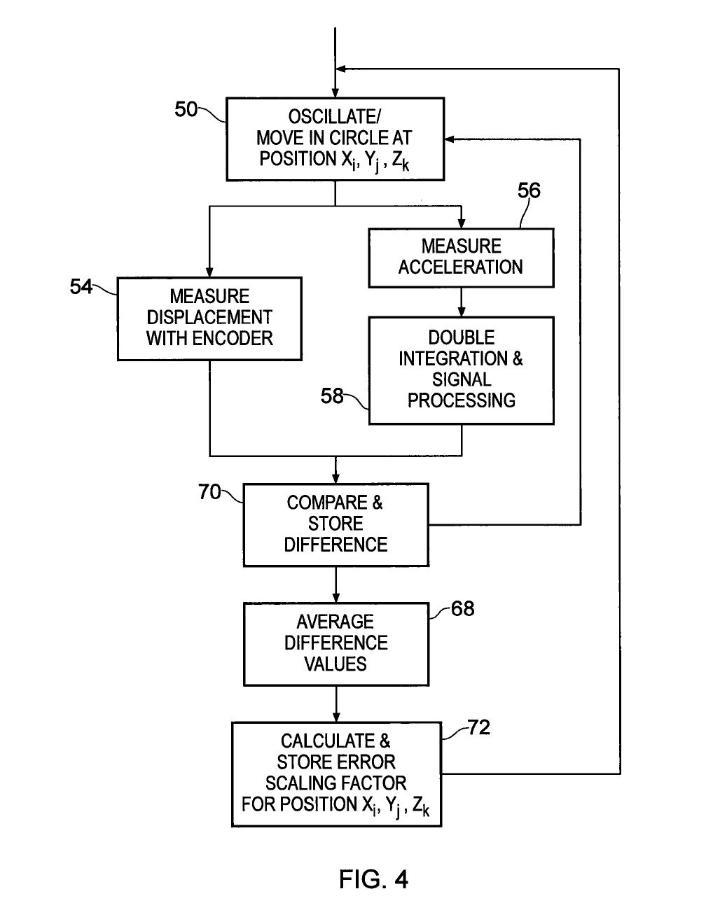

FIGS. 4 to 7 illustrate a method for calibration of the static errors of the machine of FIG. 1 or FIG. 2, with the inertial sensor arrangement 25, 125 mounted on the movable platform 32 (FIG. 1), or on the movable quill 118 (FIG. 2). This mounting position of the inertial sensor arrangement assumes that the structure of the machine is rigid (stiff) enough, relative to the desired measurement accuracy, as discussed above and below. The method can readily be modified as appropriate when sensors 150 are associated with individual axes X, Y, Z.

The preferred calibration methods according to the invention require that the machine is exercised so that the inertial sensor arrangement 25, 125 performs a movement which displaces it over a certain distance d. This displacement d is then measured by both the position measurement system to be calibrated, and by the inertial sensor arrangement, and the results are compared.

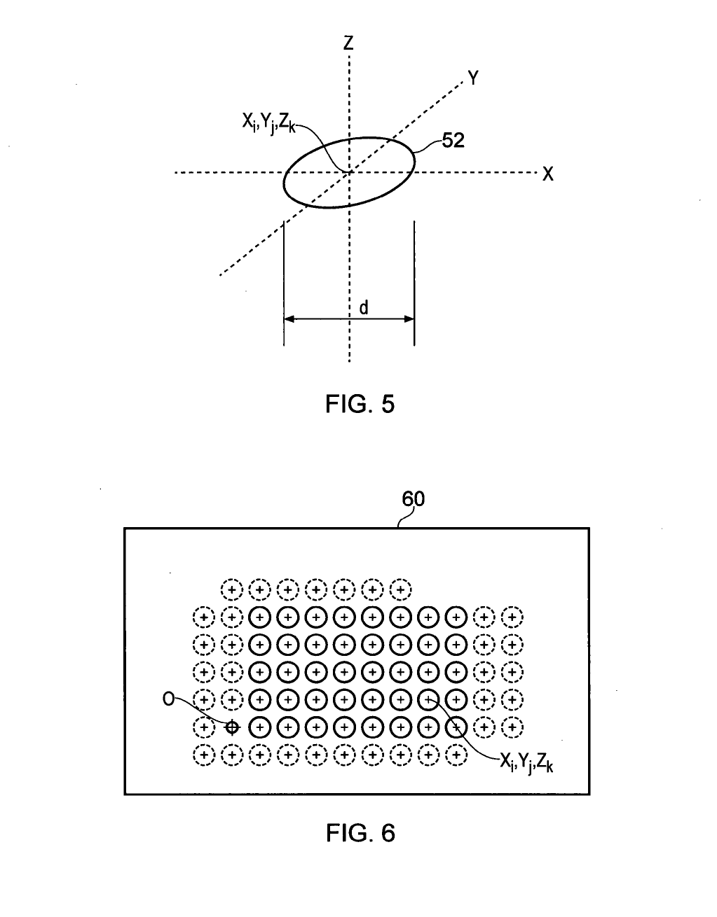

As shown in step 50 in FIG. 4, and diagrammatically in FIG. 5, the controller/computer 8, 108 is programmed to cause the platform 32 or quill 118 to describe a small circle 52 in the X-Y plane, centred about a position Xᵢ, Yⱼ, Zₖ. This is effectively an oscillation in both the X direction and the Y direction, with an amplitude (the magnitude d of the displacement in this example) corresponding to the diameter of the circle. Of course, a simple oscillation in each direction individually can be used instead, e.g. if sensors 150 associated with individual axes X, Y, Z are used. While not preferred, it is also envisaged that a simple linear displacement over a corresponding distance d can be performed, starting and stopping at each end of the displacement.

The displacement caused by the oscillation in one direction (e.g. X) will be considered below. The oscillation in the Y direction is treated similarly. Furthermore, in order to build up a three-dimensional error map, the oscillation is repeated by causing the platform 32 or quill 118 to describe similar circles in the X-Z and Y-Z planes, giving two sets of oscillation data for each direction X, Y, Z at the position Xᵢ, Yⱼ, Zₖ which can be combined subsequently, e.g. during the averaging step 68 discussed below.

In step 54, a value for the magnitude d of the displacement (amplitude of the oscillation) is measured by the corresponding transducer of the position measuring system, e.g. the encoders such as 128 in FIG. 2, or calculated from the encoders in the actuators 36 (FIG. 1).

A value for the magnitude d of the displacement (amplitude of the oscillation) is also measured simultaneously by the inertial sensor system, in steps 56 and 58. In step 56, the acceleration of the platform 32 or quill 118 is determined from the accelerometers 40 (three translational accelerations Ax, Ay, Az). The acceleration is then double integrated in step 58, to produce the magnitude d of the displacement. Step 58 may also include further processing of the acceleration signals, such as high pass filtering to remove drift.

The measurements of the displacement d by the encoders (position measuring system) and by the inertial sensors are then compared in step 70. This yields a difference value, which as discussed below represents the static error in the measurement by the position measuring system at the position Xᵢ, Yⱼ, Zₖ, over the distance of the displacement din the X direction. This difference value is stored temporarily.

Although one cycle may be sufficient, the oscillation in step 50 (e.g. circular movement 52) is preferably repeated for multiple cycles. This enables the measurements of the displacement d by the encoders (step 54) and by the inertial sensors (steps 56, 58) to be repeated multiple times, e.g. ten times. On each repetition, the measurements of d are compared and the difference values stored temporarily (step 70). After a suitable number of repetitions, the difference values are averaged (step 68) to improve accuracy.

As an alternative, the multiple measurements of the displacement d with the encoder (step 54) may be averaged separately. Likewise the multiple displacement measurements d using the inertial sensor system (steps 56 and 58) are averaged separately. The two averaged values are then compared to produce an averaged difference value.

In step 72, an error scaling factor for the position Xᵢ, Yⱼ, Zₖ is calculated from the averaged difference value. The controller/computer 8,108 stores it in a table. This scaling factor represents the error per unit distance of the displacement d, at the position Xᵢ, Yⱼ, Zₖ. For example, if d is 10 mm, and the difference value (the error in d) is 10 μm, then the scaling factor is (10 μm/10 mm)=1 μm/mm.

As noted above, the procedure shown in FIGS. 4 and 5 is repeated for circular movements in the X-Z and Y-Z planes, or for oscillations in the Y and Z directions. This gives error scaling factors in each of the directions X, Y, Z at the position Xᵢ, Yⱼ, Zₖ.

Next the above procedure is repeated at multiple further positions Xᵢ, Yⱼ, Zₖ throughout the three-dimensional working volume of the machine. For example these positions Xᵢ, Yⱼ, Zₖ may be located in a regular three-dimensional grid pattern as shown in FIG. 6. The grid spacing need not necessarily be the same as the size of the displacement d (the diameter of the circle 52 or the amplitude of the oscillation). For example, the displacement d may be 10 mm and the grid spacing of the positions Xᵢ, Yⱼ, Zₖ may be 25 mm. The controller/computer now has a stored table of error scaling factors in the X, Y and Z directions at each of the positions Xᵢ, Yⱼ, Zₖ in the grid.

The size of the displacement d and of the spacing of the positions Xᵢ, Yⱼ, Zₖ is a trade-off which can be selected by the skilled person. For example, if the size of the displacement d is smaller, e.g. 1 mm, and the grid spacing is correspondingly smaller, then the density of the resulting error information is greater. This means that more accurate results can be obtained if the errors vary significantly from position to position within the machine's working volume. However, more time is required to produce the data. So such a reduction in the size of the displacement d and the spacing of the positions Xᵢ, Yⱼ, Zₖ may not be preferred if the errors are expected to vary less significantly.

It was mentioned above that the mounting position of the inertial sensor arrangement 25, 125 on the movable platform 32 or quill 118 assumes that the structure of the machine is rigid enough, relative to the desired measurement accuracy. Specifically, the mounting position is preferably chosen (relative to the desired measurement accuracy) such that the inertial sensor arrangement can be considered rigidly coupled to the points at which the transducers (encoders) of the position measuring system transduce the motions, and such that the inertial sensors are relatively unaffected by dynamic errors. That is, such that any dynamic errors are small compared to the static errors of the position measuring system which are to be corrected. The inertial sensors are therefore subject to the same displacements as the position measuring system transducers. In fact, over the relatively small displacements d, the inertial sensors are able to provide a more accurate measurement of the static position than the encoders of the machine's position measuring system. The difference values produced in steps 70 and 68 of FIG. 4 are therefore a measure of the static errors of the machine's position measuring system. The inertial sensors can therefore be used to calibrate the static errors of the position measuring system.

In considering whether the mechanical coupling between the inertial sensors and the transducers is sufficiently rigid, the stiffness of the machine structure should be considered in relation to its natural modes and frequencies of vibration, the speeds at which the machine components are moved during the calibration, and the accuracy requirements of the calibration. Even with a structure having relatively low stiffness, such as the serial kinematic system of FIG. 2, if the calibration of the system takes place at low speeds and accelerations, (corresponding to low frequencies relative to the natural frequencies of vibration of the structure), the structure may be considered to be sufficiently stiff. The dynamic errors experienced at the quill 118 during the calibration may then be smaller than the static errors to be corrected. They are preferably so small as to be negligible when compared to the static errors. The inertial sensors can therefore be mounted together on the quill at 125, rather than individually at 150 in association with the respective X, Y and Z axis transducers 128.

It will be appreciated that the required degree of rigidity is a natural property of a parallel kinematic machine such as seen in FIG. 1. In the case of a serial kinematic machine as in FIG. 2, it depends on the construction of the machine. Some CMMs may not be not sufficiently rigid, but a serial connected machine with more massive, rigid components (such as a machine tool) could be rigid enough.

In the event that the machine is not sufficiently rigid, the invention can still be used with inertial sensors mounted at the location 150, where they are coupled with sufficient rigidity to the point at which the transducer 150 transduces the Y axis motion.

Next it is desired to produce an error map which gives the static error in a measurement made by the position measuring system at any given position Xᵢ, Yⱼ, Zₖ relative to an arbitrary origin O. As seen in FIG. 6, when the machine moves from the origin O to any given position in the grid, this involves moving through multiple intermediate positions Xᵢ, Yᵢ, Zₖ in three dimensions. Moving through each of these intermediate positions involves a corresponding intermediate displacement in each of the directions X, Y, Z, depending on the spacing of the grid. At each intermediate position, the local X, Y, Z static errors occurring over that intermediate displacement can be calculated. This is done by multiplying the intermediate displacement in the directions X, Y and Z by the corresponding X, Y and Z scaling error factors, which the controller/computer has previously stored in step 72 for the corresponding intermediate position Xᵢ, Yⱼ, Zₖ.

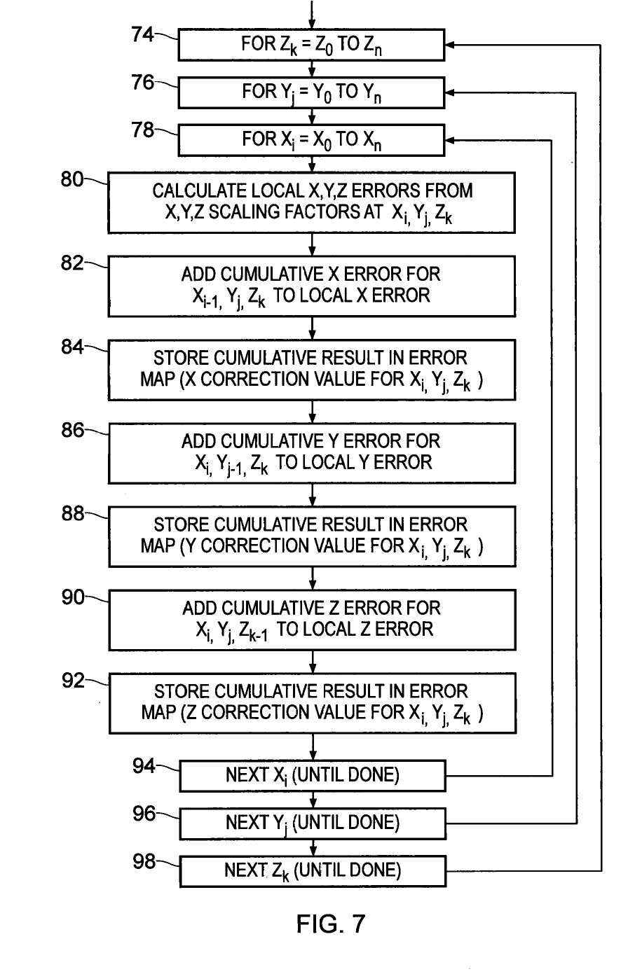

To build the error map, therefore, the controller/computer 8, 108 performs the routine shown in FIG. 7. Three nested loops 74,98; 76,96; and 78,94 step through every point Xᵢ, Yⱼ, Zₖ in the grid of the working volume of the machine, from X₀, Y₀, Z₀ to Xₙ, Yₙ, Zₙ. (This assumes the grid is a regular (n×n×n) cube; the nested loops can easily be extended for irregular cuboid grids.)

For every position Xᵢ, Yⱼ, Zₖ within the working volume of the machine, the computer calculates a three-dimensional cumulative static error value. It does this by adding together all the intermediate static error values in the displacements at all the intermediate positions between the origin O and the current position Xᵢ, Yⱼ, Zₖ.

Step 80 calculates the local error at Xᵢ, Yⱼ, Zₖ in the X, Y and Z directions, by multiplying the grid spacing by the corresponding stored X, Y and Z scaling factors. In step 82, the local X error value is integrated into the cumulative static error value, by adding it to the cumulative static error value for the preceding position in the X direction, Xᵢ₋₁, Yⱼ, Zₖ. The result is stored in step 84 as the new cumulative error value for the position Xᵢ, Yⱼ, Zₖ. This process is repeated in steps 86, 88 and in steps 90,92, to produce the Y and Z correction values at Xᵢ, Yⱼ, Zₖ from the preceding positions Xᵢ, Yⱼ₋₁, Zₖ and Xᵢ, Yⱼ, Zₖ₋₁ in the Y and Z directions respectively. The process is repeated in the loops to obtain the X, Y and Z correction values for all positions in the grid, and for all the other intermediate positions Xᵢ, Yⱼ, Zₖ seen in FIG. 6.

This gives an error map, comprising X, Y, Z correction values for the static error of a measurement by the position measurement system (encoders) at any position Xᵢ, Yⱼ, Zₖ in the machine's working volume. The correction values may be stored in a look-up table. During normal use of the machine to measure workpieces, these corrections are applied to the measurements made.

It was described above that if necessary, the displacement as measured using the inertial sensors may have been directly calibrated for static errors against an external reference standard. However, as a simpler alternative to such direct calibration, the following indirect method can be used instead.

The static errors in the displacement measurements by the position measuring system of the machine will typically vary from place to place within the working volume of the machine. However, we can assume that any static errors in the displacement measurements made using the inertial sensors are repeatable and do not vary from place to place. In consequence, if uncorrected, the static errors in the inertial sensor measurements may show up simply as constant multipliers for X, Y and Z. These multipliers affect the difference values produced in steps 70 and 68 (FIG. 4); the error scaling factors calculated in step 72; and the correction values in the error map produced in FIG. 7.

To correct for these static errors of the inertial sensor measurements, a calibrated reference standard such as a gauge block or ring gauge or reference sphere is placed on the table 12, 112 of the machine. It is measured using the probe 16, 116, in each of the dimensions X, Y Z. Suitably this is done after the error map has been produced in FIG. 7. The X, Y, Z measurements of the reference standard are corrected using the error map, and then compared with the known calibrated X, Y, Z dimensions of the reference standard. This gives the appropriate X, Y, Z multipliers. Either all correction values in the error map are corrected with the corresponding multiplier, or the multipliers are applied to all subsequent measurements after correction by the error map.

It would instead be possible to correct the difference values in steps 68, 70 or the error scaling factors in step 72 with the appropriate multipliers.

As an alternative to an error map of correction values, the computer may instead build a set of error functions used to derive a correction value whenever a measurement of a workpiece is made at a position Xᵢ, Yⱼ, Zₖ. The error functions may be stored, for example, as Fourier coefficients.

The inertial sensor arrangement is not required during normal use of the machine to measure workpieces. It may therefore be housed in a module which is removed from the machine after the calibration, and which can also be used when calibrating other machines.

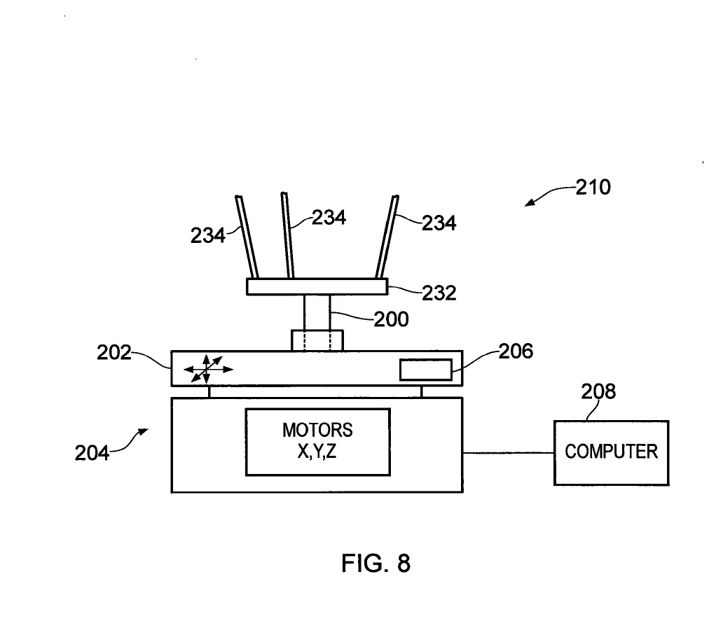

The above embodiments of the invention have been described in relation to motorised machines whose movements can be programmed and controlled by a computer or controller. FIG. 8 shows an alternative embodiment, for use with a manually operated machine. As an example, part of a parallel kinematic machine 210 similar to FIG. 1 is shown, having a platform 232 and extensible and retractable struts 234. However, this manual machine has no motors, the actuators 36 being replaced just by transducers (not shown) to measure the extension of each respective strut. In normal use, a measurement probe or other tool (not shown) is fitted to the platform 232. Other manual machines can be used, e.g. serial machines as in FIG. 2, or a coordinate measuring articulating arm having serially connected rotary joints.

Prior to use, a calibration is performed in the same manner as above, for example with the probe or tool removed. A rod 200 temporarily connects the platform 232 to the movable part 202 of a motorised stage 204. The part 202 is movable in X, Y and Z directions, under the control of a computer 208 connected to the stage 204. The stage 204 can then drag the platform 232 in X, Y and Z directions, under the control of the computer 208.

An inertial sensor arrangement 206 is provided on the movable part 202 of the stage (or it could be temporarily fitted to the platform 232). It is similar to the inertial sensor arrangements 25,125 in FIGS. 1 and 2. The computer 208 is programmed to perform a calibration as above, comparing displacement measurements made using the outputs of the inertial sensor arrangement 208 with measurements made using the transducers of the manual machine 210. An error map or error function is generated to correct static errors of the machine, in a similar manner to that described above.

1. A method of calibrating static errors in a motion system, the system comprising:
a relatively fixed member and a relatively movable member; and
a position measuring system for determining the position of the movable member relative to the fixed member, the determination being subject to static errors;
the method comprising:
providing one or more inertial sensors which are arranged to move with the movable member and to measure displacements of the movable member;
causing a displacement of the movable member relative to the fixed member;
determining a value relating to said displacement using the one or more inertial sensors;
determining a value relating to said displacement using the position measuring system; and
comparing the value relating to the displacement as determined using the position measuring system with the value relating to the displacement as determined using the one or more inertial sensors;
wherein:
the comparison produces a difference value for use in subsequent correction of one or more static errors of the position measuring system.

2. A method of calibrating static errors according to claim 1, wherein the value relating to the displacement determined using the one or more inertial sensors is less subject to static error than the position measuring system.

3. A method of calibrating static errors according to claim 1, wherein the value relating to the displacement as determined using the one or more inertial sensors is calibrated against a reference standard external to the motion system.

4. A method of calibrating static errors according to claim 1, including correcting for static error in the value relating to the displacement as determined using the one or more inertial sensors by measurement of a reference standard on the motion system.

5. A method of calibrating static errors according to claim 1, wherein any dynamic errors in the measurements of the inertial sensor(s) are small compared to the static error of the position measuring system.

6. A method of calibrating static errors according to claim 5, wherein the inertial sensor(s) are mounted at a part of the motion system which is mechanically coupled to the point(s) at which transducer(s) of the position measuring system transduce its motion; the mechanical coupling being sufficiently rigid to assure that any dynamic errors in the measurements made using the inertial sensor(s) are small compared to the static error of the position measuring system.

7. A method of calibrating static errors according to claim 6, wherein the displacement of the movable member during the calibration is an oscillation at a frequency where the mechanical frequency response of the system assures that the mechanical coupling is sufficiently rigid.

8. A method of calibrating static errors according to claim 1, wherein the one or more inertial sensors include one or more accelerometers.

9. A method of calibrating static errors according to claim 8, wherein the amount of the displacement determined by the one or more accelerometers is obtained by double integrating the accelerometer output or outputs.

10. A method of calibrating static errors according to claim 1, wherein the movable member is movable over a relatively large range, and the steps of determining the values relating to the displacement of the movable member take place over a relatively small range.

11. A method of calibrating static errors according to claim 10, wherein the displacement over the small range is produced by an oscillation of the movable member.

12. A method of calibrating static error according to claim 11, wherein the determinations of the values relating to the displacement of the movable member are repeated during the oscillation, and the difference value is averaged from the repeated determinations.

13. A method of calibrating static errors according to claim 1, wherein the oscillation is produced by a circular motion of the movable member.

14. A method of calibrating static errors according to claim 1, wherein respective said difference values are produced for displacements caused at a plurality of relative positions of the fixed and movable members, and the difference values are used to form an error map or error function of the static errors of the motion system.

15. A method of calibrating static errors according to claim 10, wherein the step of displacing the movable member over a small range and the steps of determining the values relating to its displacement are repeated at a plurality of different relative positions of the fixed and movable members, to produce a respective difference value for each position.

16. A method of calibrating static errors according to claim 15, wherein a cumulative error of a position measurement made using the position measuring system over a relatively large range of movement of the movable member is calculated by integrating a plurality of said difference values for positions lying within the relatively large range.

17. A method of calibrating static errors according to claim 16, wherein an error map or error function is derived, giving a respective cumulative error for each of a plurality of positions of the movable member.

18. A method of using a motion system, the system comprising a relatively fixed member, a relatively movable member and a position measuring system for determining the position of the movable member relative to the fixed member, the determination being subject to static error;
the method comprising
determining the position of the movable member relative to the fixed member, using the position measuring system; and
correcting a static error of the determined position of the movable member by applying a correction derived from a difference value or error map or error function obtained by a method of calibrating static errors according to claim 1.

19. A motion system comprising a relatively fixed member, a relatively movable member and a position measuring system for determining the position of the movable member relative to the fixed member, the determination being subject to static errors;
wherein the system further comprises a controller or computer configured to perform a method of calibrating static errors according to claim 1.

20. A motion system comprising a relatively fixed member, a relatively movable member and a position measuring system for determining the position of the movable member relative to the fixed member, the determination being subject to static errors;
wherein the system further comprises a controller or computer in which is stored a difference value or error map or error function obtained by a method of calibrating static errors according to claim 1.

21. A motion system according to claim 19, wherein the inertial sensor(s) are removable from the movable member.

22. A motion system according to claim 19, in which the movable member is connected to the fixed member by a parallel kinematic structure.

23. A motion system according to claim 19, including a probe for measuring a workpiece, the probe being mounted to the movable member.
